(19) United States
(12) Patent Application Publication
(10) Pub. No.: US 2025/0295153 A1
(43) Pub. Date: Sep. 25, 2025

(54) TEXTURIZED FRUIT-LIKE INCLUSION PRODUCT

(71) Applicant: SOCIETE DES PRODUITS NESTLE S.A., Vevey (CH)

(72) Inventors: MATTHIAS FROMMHAGEN, Lausanne (CH); CHRISTINA VAFEIADI, Lausanne 26 (CH); ADRIENNE SARAH JONES, York (GB); ANDREW STEVEN WHITEHOUSE, Harrogate, Yorkshire (GB); ELIF BUYUKPAMUKCU, Lausanne (CH); JULIEN TERRAPON, L'Abergement (CH)

(21) Appl. No.: 18/835,501

(22) PCT Filed: Feb. 3, 2023
(86) PCT No.: PCT/EP2023/052651

§ 371 Date: Aug. 2, 2024

(30) Foreign Application Priority Data
Feb. 4, 2022 (EP) 22155249.0

(51) Int. Cl. A23L 21/18; A23G 3/34; A23G 3/36; A23G 3/42; A23G 3/48; A23L 19/00

(52) U.S. Cl. CPC A23L 21/18; A23G 3/0027; A23G 3/366; A23G 3/42; A23G 3/48; A23L 19/09

(57) ABSTRACT

The invention relates to a method of making a texturized fruit-like inclusion product, said product comprising 50 to 80 wt % non-dietary fiber carbohydrate; and 5 to 20 wt % dietary fiber. The ratio of wt % dietary fiber to wt % non-dietary fiber carbohydrate is between 1:10 to 1:2, preferably between 1:5 to 1.4. The invention further relates to a texturized fruit-like inclusion product, wherein said product comprises ingredients derived from different fruit sources. The use of a pectin methyl esterase source derived from a papaya plant to make a texturized fruit-like inclusion product is also described.

### CROSS-REFERENCE TO RELATED APPLICATIONS

The present application is a National Stage of International Application No. PCT/EP2023/052651, filed on Feb. 3, 2023, which claims priority to European Patent Application No. 22155249.0, filed on Feb. 4, 2022, the entire contents of which are being incorporated herein by reference.

### TECHNICAL FIELD

The invention relates to a method of making a texturized fruit-like inclusion product that comprises a high dietary fiber to non-dietary fiber carbohydrate ratio.

### BACKGROUND

Current consumer trends show an increased demand for confectionery products with an exciting texture and a healthy appearance. Industrially produced alternatives to dried fruit pieces are often not resembling these properties of dried fruit.

Many of these alternatives have the appearance of gelled or gummy-like pieces, rather than a dried fruit piece. Consequently, the texture can be rubbery, which is caused by the addition of thickening agents, such as pectins, gellan gums or gelatin. The latter ingredient limits the application of such pieces in vegan products. As these thickening agents and the added sugars are mainly responsible for the textural properties of such pieces, current products are often not only brittle, sticky or jelly, but also limited regarding their application in confectionery processes where physical and thermal treatments are applied.

Moreover, nutritional trends are directed towards healthier products, and current products on the market are not meeting consumer needs in this area.

### SUMMARY OF INVENTION

The inventors have developed a texturized fruit-like inclusion product which more closely resembles dried fruit, particularly with regard to the tenderness of fruit pieces.

The texturized fruit-like inclusion product can thus be described as having a tender fruit texture, fruit taste and colour. Moreover, the fruit-like inclusion product is technically compatible with confectionery processes. It is generally shelf stable from between 9 to 12 months. It typically comprises mainly of fruit fibers, fruit purees & fruit extracts. It is flavoured and can be varied to resemble dried fruits, such as blueberry, sweet & sour cherry, coffee cherry, and the like.

The invention relates to a texturized fruit-like inclusion product, said product comprising
a. 50 to 80 wt % non-dietary fiber carbohydrate; and
b. 5 to 20 wt % dietary fiber;

In one embodiment, between 10 to 40 wt % of the dietary fiber is composed of uronic acid residues, preferably 15 to 30 wt % of the dietary fiber is composed of uronic acid residues. In one embodiment, the dietary fiber is at least 20% demethylated.

In one embodiment, the product comprises a deactivated pectin methylesterase source.

Typically, the pectin methylesterase source is a papain preparation derived from a papaya plant, for example Carica papaya.

In one embodiment, the dietary fiber and non-dietary fiber carbohydrate are present in the product wt % ratio between 1:10 to 1:2, preferably between 1:5 to 1:4.

In one embodiment, the product comprises up to 2 wt % calcium source, preferably between 0.1 to 2 wt % calcium source.

In one embodiment, the product comprises between 20 to 30 wt %, preferably about 25 wt % glucose syrup. In an embodiment, glucose syrup contributes up to 50% of the non-dietary fiber carbohydrate content of the product.

In one embodiment, the product has a fructose to glucose ratio of between 1:1 to 4:1, preferably 1:1 to 2:1.

In one embodiment, the dietary fiber is derived from a cocoa, sugar beet, citrus, apple, blueberry or cherry source. Preferably, the dietary fiber is citrus fiber.

In one embodiment, the calcium source is calcium chloride, for example calcium chloride dihydrate.

In one embodiment, the product has a water activity (Aw) between 0.45 and 0.65. In one embodiment, the product has a pH of about 3.4. In one embodiment, the product has a TS content of between 80 to 95%. In one embodiment, the product further comprises a flavoring agent.

In one embodiment, the product is a blueberry, cherry, apricot, blackcurrant, cascara, coffee mucilage, or strawberry texturized fruit-like inclusion product. Preferably, the product is a blueberry, cherry, cascara, or coffee mucilage texturized fruit-like inclusion product.

In one embodiment, the invention relates to a texturized fruit-like inclusion product comprising a non-dietary fiber carbohydrate content between 50 to 80 wt %, a dietary fiber content ranging from 5 to 20 wt %, a calcium source ranging between 0.1 to 2 wt %, and optionally a deactivated pectin methylesterase source.

In one embodiment, the product comprises a non-dietary fiber carbohydrate content between 52.5 to 96%, between 5.25-24% dietary fiber, and between 1.1-2.4% calcium source on a moisture free basis.

Typically, the texturized fruit-like inclusion product comprises a non-dietary fiber carbohydrate to dietary fiber ratio ranging from 4 to 6, preferably ranging from 4.7 to 5.5.

Typically, the texturized fruit-like inclusion product comprises ingredients derived from more than one fruit source.

In one embodiment, the product comprises ingredients derived from apple and blueberry, for example apple puree concentrate, apple juice concentrate, apple fiber, citrus fiber, blueberry puree, blueberry powder, or blueberry flavor, preferably apple puree concentrate and blueberry powder; or apple juice concentrate, blueberry puree, and blueberry juice concentrate.

Typically, the product is devoid of animal derived ingredients. The product is thus suitable for vegans.

The invention further relates to a food product, preferably a confectionery product, for example a cereal bar, chocolate bar, a biscuit, a topping, or a filling, comprising a texturized fruit-like inclusion product according to the invention.

The invention further relates to a texturized fruit like inclusion product made by a method according to the invention.

The invention further relates to a method of making a texturized fruit-like inclusion product, said method comprising
a. Mixing a non-dietary fiber carbohydrate source and a dietary fiber source in water to form a mixture;
b. Optionally cooling the mixture, for example to below 10° C.;
c. Optionally adding a pectin methyl esterase source to the mixture;
d. Incubating the mixture so that the temperature of the mixture reaches between 40 to 65° C.;
e. Optionally heating the mixture to deactivate the pectin methyl esterase;
f. Drying the mixture; and
g. Cutting the mixture to form a product.

In one embodiment, the mixture comprises fruit juice concentrate, for example with a Brix value of about 70.

In one embodiment, the pectin methyl esterase source is added to the mixture before cooling step b).

In one embodiment, the pectin methyl esterase source is added to the mixture after cooling step b).

In one embodiment, the core temperature of the mass reaches at least 71° C. for at least 2 minutes in step e).

In one embodiment, at least 20% between 10 to 40 wt % of the dietary fiber is composed of uronic acid residues, preferably 15 to 30 wt % of the dietary fiber is composed of uronic acid residues. In one embodiment, the dietary fiber is at least 20% demethylated.

In one embodiment, the mixture comprises a deactivated pectin methylesterase source. Typically, the pectin methylesterase source is a papain preparation derived from a papaya plant.

In one embodiment, the dietary fiber and non-dietary fiber carbohydrate are mixed in a wt % ratio of between 1:10 to 1:2, preferably between 1:5 to 1:4.

In one embodiment, the mixture comprises a calcium source.

In one embodiment, the mixture comprises glucose syrup.

In one embodiment, the mixture has a fructose to glucose ratio of between 1:0.8 to 3:1, preferably 1:1 to 2:1.

In one embodiment, the mixture comprises ingredients derived from different fruit sources, for example apple and blueberry.

In one embodiment, the dietary fiber is derived from a cocoa, sugar beet, citrus, apple, blueberry or cherry source. Preferably, the dietary fiber is citrus fiber.

In one embodiment, the calcium source is calcium chloride, for example calcium chloride dihydrate.

In one embodiment, the product has a water activity (Aw) between 0.45 and 0.65. In one embodiment, the product has a pH of about 3.4. In one embodiment, the product has a TS content of between 80 to 95%. In one embodiment, the product further comprises a flavoring agent.

In one embodiment, the product is a blueberry, cherry, apricot, blackcurrant, cascara, coffee mucilage, or strawberry texturized fruit-like inclusion product. Preferably, the product is a blueberry, cherry, cascara, or coffee mucilage texturized fruit-like inclusion product.

In one embodiment, the invention relates to a texturized fruit-like inclusion product comprising of a non-dietary fiber carbohydrate content between 50 to 80 wt %, a dietary fiber content ranging from 5 to 20 wt %, and a calcium source ranging between 0.1 to 2 wt %.

Typically, the texturized fruit-like inclusion product comprises a non-dietary fiber carbohydrate to dietary fiber ratio ranging from 4 to 6, preferably ranging from 4.7 to 5.5.

Typically, the texturized fruit-like inclusion product comprises ingredients derived from more than one fruit source.

In one embodiment, the product comprises ingredients derived from apple and blueberry, for example apple puree concentrate, apple juice concentrate, apple fiber, citrus fiber, blueberry puree, blueberry powder, or blueberry flavor, preferably apple puree concentrate and blueberry powder; or apple juice concentrate, blueberry puree, and blueberry juice concentrate.

The invention further relates to use of a pectin methyl esterase source to make a texturized fruit-like inclusion product.

In one embodiment, the pectin methyl esterase source is derived from a papaya plant.

### DETAILED DESCRIPTION OF THE INVENTION

### Definitions

When a composition is described herein in terms of wt %, this means a mixture of the ingredients on a wet basis, unless indicated otherwise.

As used herein, “about”, or “approximately”, or “similar” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 45 to 55 should be construed as supporting a range of from 46 to 54, from 48 to 52, from 49 to 51, from 49.5 to 50.5, and so forth.

The meanings of the terms “dietary fiber” and “non-dietary fiber carbohydrate” are based on the CODEX Alimentarius Commission (CAC) as described in Jones, J. M. CODEX-aligned dietary fiber definitions help to bridge the ‘fiber gap’. Nutr J 13, 34 (2014).

As used herein, the term “dietary fiber” means carbohydrate polymers with 10 or more monomeric units, which are not hydrolysed by endogenous enzymes in the small intestine of humans.

As used herein, the term “non-dietary fiber carbohydrate” means carbohydrates which are not defined as dietary fiber by the CAC, like sugars below the degree of polymerization (DP) of 3.

### Method of Making the Fruit-Like Inclusion Product

The process to make the product of the invention involves a) mixing of the ingredients, b) optionally cooling, c) optionally adding enzyme, d) incubating the mixture or mass, e) optionally heating, f) drying, and g) cutting the mixture or mass to form a product.

In step a) the ingredients, including the non-dietary fiber carbohydrate source and the dietary fiber source, are typically added under agitation, for example at about 300 rpm. The mixing step is typically between 5 to 30 minutes. In step b), the mass is typically cooled to below 10° C.

All the dry ingredients can then be added and then stirred to homogeneity, for example at about 300 rpm for about 10 minutes. The resulting mass is then spread out, for example in a baking mold, to a typical thickness of about 5 to 10 mm.

In step f), the mixture can be heated at about 95° C. in an air oven for 1 to 2 hours. The core temperature of the mass should reach 71° C. for at least 2 minutes. The mass is then oven dried with air circulation, typically at 95° C. for 3 to 18 hours. After drying, the dried mass is cooled towards room temperature. In step g), the mixture is then cut into pieces to yield the texturized fruit like inclusion product.

The process may be adapted as shown in Example 2. The adapted process can include step c) enzyme addition, step d) incubation, and step e) enzyme deactivation. The enzyme may be added in powdered form, for example between 0.1 to 0.5 wt % based on initial ingredient weight. The solubilized enzyme preparation can then be added to the homogenous mass under agitation, for example at 300 rpm.

The mass can then be spread out or molded onto a baking plate to achieve a mass thickness of between 5 to 10 mm. A three step heating process can then be applied using a conventional oven. First, the molded mass is incubated, typically at 45° C. for 1 hour. Second, the molded mass is heated at 95° C. for between 1 to 2 hours. Typically, the core temperature of the mass is above 71° C. for at least 2 mins. The mass is then oven dried with 100% air circulation at 95° C. for between 3 to 18 hours.

The method of making the product may be the same or similar to that used for making the product described in any one of preferred examples 7, 8, 9, 20, 21, 23, 25, 27, 29, 36, and 37 as described herein.

### Ingredient Amounts in the Product

The apple puree concentrate can be present at between 45 wt % to 60 wt %, for example about 50 wt % or about 55 wt %. Alternatively, it can be present in lower amounts like in Examples 7, 8, and 23. For example, the apple puree concentrate can be present at between 10 to 20 wt %, or at about 15 wt %.

The glucose syrup can be present at between 5 wt % to 23 wt %, or between 9 wt % to 19 wt %, for example about 10 wt % or about 18 wt %. Alternatively, it can be present in higher amounts like in Example 6. For example, the glucose syrup can be present at about 25 wt %.

The apple juice concentrate can be present at between 10 wt % to 22 wt %, for example about 14 wt % or about 18 wt %. Alternatively, it can be present at higher amounts like in Examples 7, 8, 20, 21, and 23. For example, the apple juice concentrate can be present at between 23 wt % to 30 wt %, for example about 26.8 wt % or about 25 wt %.

The apple fiber can be present at between 7 wt % to 9 wt %, for example about 8 wt %. Alternatively, it can be present at lower amounts like in Examples 7 and 8. For example, the apple juice concentrate can be present at between 3 wt % to 7 wt %, for example about 5 wt %.

The citrus fiber can be present at between 1.5 wt % to 5 wt %, for example about 2 wt % or 3 wt %.

The blueberry powder can be present at between 3 wt % to 6 wt %, for example about 4.9 wt %.

The citric acid can be present at about 0.1 wt %.

The blueberry flavor can be present at about 1 wt %.

The calcium chloride dihydrate can be present at about 0.6 wt %.

The papain preparation can be present at about 0.3 wt %.

The total solid (TS) content of the product can be about 85% or 90%, typically after drying at about 80° C. for about 3.5 hours.

The water activity (A_{w}) of the product can be about 0.55 or about 0.58. Alternatively, it can be lower like in Examples 5 and 6. For example, the water activity can be about 0.48 or about 0.52.

The moisture content of the product can be between 10 wt % to 20 wt %, for example about 13 wt % or about 15 wt %.

The sodium content of the product can be between 10 mg to 25 mg, for example about 17 mg or about 19 mg per 100 g of product.

The uronic acid content of the product can be between 2.5 wt % to 5 wt %.

### Ingredient Specifications

The apple puree concentrate may have one or more of the following characteristics. The ° Brix may be between 25-35. The pH may be between 3 to 5. The TS (%) may be between 25 to 40%. The Brix refraction may be between 65 to 75.

The apple fiber may have one or more of the following characteristics. The moisture content may be between 1-15%. The pH may be between pH 2.5-6.5. The total dietary fiber content may be between 50 to 70%. The soluble fiber content may be between 5 to 15%. The insoluble fiber content may be between 40 to 60%.

The glucose syrup may have one or more of the following characteristics. The dry matter may be over 75%. The pH may be between 3-6.

The apple juice concentrate may have one or more of the following characteristics. The ° Brix may be between 65 to 75. The acidity (calculated as CAA, pH=8,1) may be between 1 to 3 g/100 g.

The blueberry powder may have one or more of the following characteristics. The residual moisture maximum may be between 1 to 9% (based on weight). The sieve analysis (over 1.25 mm) may be between 1 to 9%.

The blueberry flavor may have one or more of the following characteristics. The Water/Acetic Acid E260 may be between 0.5 to 2.0%.

The Citrus fiber may have one or more of the following characteristics. The humidity may be less than 15%. The particle size (<150 μm) may be over 85%. The dietary fiber content may be between 85 to 95%.

The Sweet Cherry Puree may have one or more of the following characteristics. The ° Brix may be between 10 to 20. The acidity (% A.C.A.) may be between 0.75 to 1. The pH may be between 3 to 4.5. The pulp (%) may be between 45 to 60.

The coffee mucilage may have a non-dietary fiber carbohydrate content over 55%.

The pectin methyl esterase source is typically a papain preparation, preferably derived from a papaya plant. For example, the papain may be obtained from the dried latex of the fruit of Carica papaya. The papain preparation is typically a proteolytic enzyme product. It also comprises enzymes of the class carbohydrate esterases, in particular, pectin methylesterases. The protein content of the used papain preparation is typically in the range from 20 to 95% wt.

### Product Nutritional Values

The energy content of the product can be between 1000 kJ to 1500 kJ, for example about 1250 kJ or about 1295 kJ per 100 g of product. The fat content of the product can be between 0.5 g to 1.5 g, for example about 0.7 g or 0.9 g per 100 g of product. The protein content of the product can be between 1 g to 2.5 g, for example about 1.6 g or about 1.9 g per 100 g of product. The non-dietary fiber carbohydrate content of the product can be between 50 g to 75 g, for example about 63 g or about 66 g per 100 g of product. The dietary fiber content of the product can be between 10 g to 20 g, for example about 12 g or about 14 g per 100 g pf product.

The low molecular weight dietary fiber content of the product can be between 1.5 wt % to 5 wt %. The insoluble high molar weight dietary fiber content of the product can be between 5 wt % to 10 wt %. The soluble high molar weight dietary fiber content of the product can be between 1.5 wt % to 5 wt %. The ratio of non-dietary fiber carbohydrate to dietary fiber content of the product can be between 3.5 wt % to 6 wt %. These fiber analysis values are based on AOAC 2011.25-M.

The invention is further described with the reference to the following examples.

### Product Recipes

The product may comprise the ingredients as shown in Example 3, but with the following differences: between 47 to 52 wt % apple puree concentrate, or about 49.7 wt percent apple puree concentrate; between 15 to 20 wt % glucose syrup or about 18.4 wt % glucose syrup; between 12 to 16 wt % apple juice concentrate or about 14 wt % apple juice concentrate. In one embodiment, the product has the same ingredient contents as example 5, wherein the ingredient amounts vary by up to 20%.

The product may comprise the ingredients as shown in Example 5, but with the following differences: between 22 to 28 wt % glucose syrup, or about 25 wt % glucose syrup; about 25 wt % apple juice concentrate; about 6 wt % apple fiber; and about 3 wt % citrus fiber. In one embodiment, the product has the same ingredient contents as example 6, wherein the ingredient amounts vary by up to 20%.

The product may comprise the same ingredient as any one of examples 7, 8, 9, 20, 21, 23, 25, 27, 29, 36, and 37 wherein the ingredient amounts vary by up to 20%.

In some embodiments, the glucose syrup may at least in part be substituted with oat bran syrup, resistant dextrins, or soluble dietary fiber. These alternatives would contribute to the (soluble) fiber content. As a result, the glucose content will decrease and the (soluble) fiber content will increase. In such cases, the ingredient ranges would be non-dietary fiber carbohydrates between 30-80 wt %; dietary fiber between 5 to 40 wt %; and the ratio of dietary fiber to non-dietary fiber carbohydrate would be between 1:10 to 1:1.

### EXAMPLES

### Example 1

### Method of Making the Fruit-Like Inclusion Product

The general method of making the texturized fruit-like inclusion product involves the steps of a) mixing of the ingredients, b) optionally cooling, c) optionally adding enzyme, d) incubating the mixture, e) optionally heating, f) drying, and g) cutting the mixture to form a product.

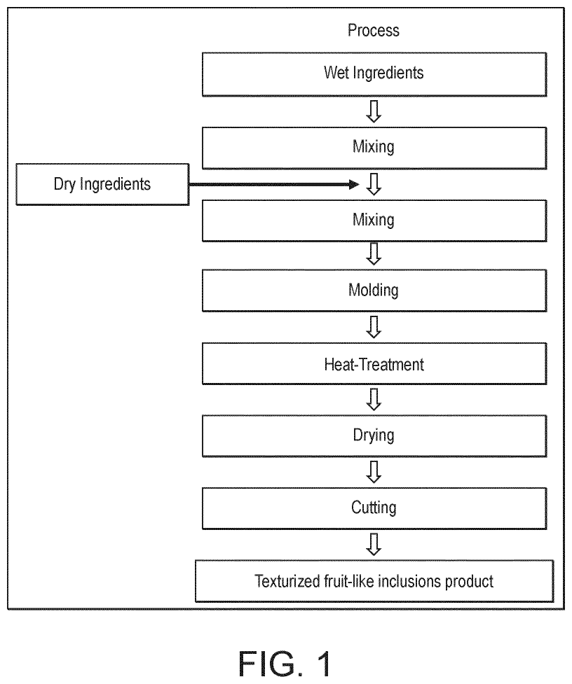

First, the wet ingredients, such as purees and fibers, were added under agitation (300 rpm) to obtain a homogenous mass. The agitation was conducted using an automated stirring device, such as a Stephan Mixer equipped with a double mantel jacket (Stephan universal mixer UMSK 24E). During this mixing step, which took 5 to 30 min, the mass was cooled to a temperature below 10° C. to ensure microbial safety. Afterwards, the dry ingredients were pre-mixed (manual), and slowly added to the wet mix under continuous agitation at 300 rpm and cooling (<10° C.). After the addition of all dry ingredients, the mass was stirred until homogeneity at 300 rpm for another 10 min under cooling (<10° C.). The homogenous mass was then spread out (moulded) onto a baking plate to achieve a mass thickness of 5 to 10 mm. The mass was heat-treated in a conventional oven (MKN HansDampf) with air circulation (100%) at 95° C. for 1-2 hours, to achieve a core temperature of the mass above 71° C. for at least 2 min. Afterwards, the mass was oven dried with an air circulation of 100% at 95° C. for 3-18 hours, depending on the number of oven plates, thickness and size of the moulded sample in the oven. After drying, the dried mass was cooled towards room temperature at cut into pieces which yielded to the texturized fruit-like inclusion product. The size ranged from 3 to 10 mm, or above, depending on the foreseen application. A process overview is presented in FIG. 1.

To ensure the microbial stability and safety of the process, as to monitor the progress of the drying, the following methods were used. The dry matter (total solids, TS %) was determined before and after the drying process using a moisture analyzer (HC103 & HR73, Mettler Toledo). The pH of the homogenous mass was determined using a pH meter. The A_{w} (water activity) of the mass and texturized fruit-like inclusion product was monitored using an A_{w} analyzer Aqualab 4TE (METER Group, Inc. USA).

### Example 2

Method of Making Fruit-Like Inclusion Product with Enzyme Addition

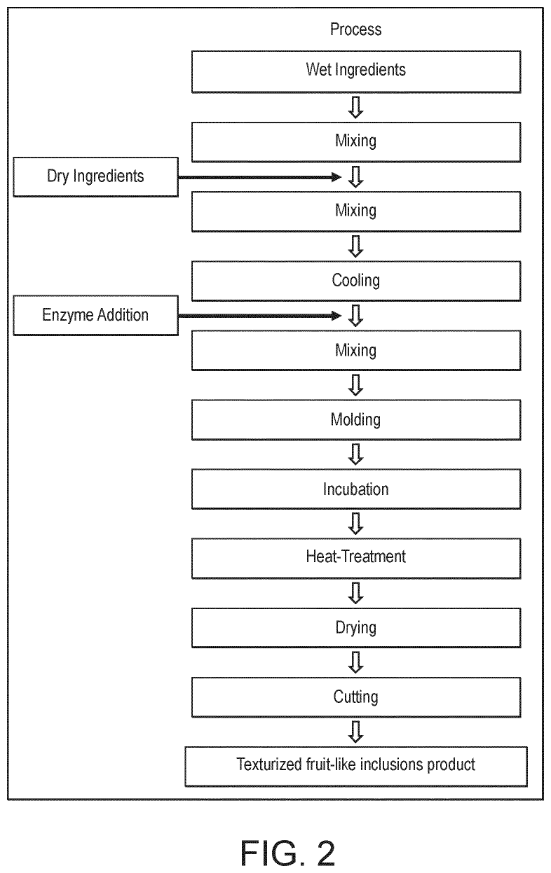

Based on the Example 1, an adapted process was developed that included an enzyme addition, incubation and deactivation (heat-treatment) step (FIG. 2).

As described for Example 1, the wet and dry ingredients were mixed until a homogenous mass was obtained. As the enzyme was a powdered preparation, the required amount of enzyme (0.1 to 0.5% wt based on initial ingredient weight) was solubilized in water under high shear, such as agitation at 2000-3000 rpm using a Silverson Mixer (Silverson). The solubilized enzyme preparation was added to the homogenous mass under agitation at 300 rpm and mixed for 5 min under cooling (<10° C.). The enzyme-treated homogenous mass was then spread out (moulded) onto a baking plate to achieve a mass thickness of 5 to 10 mm. A 3-step heating process was applied using a conventional oven (MKN HansDampf) with air circulation (100%). First, the moulded mass was incubated at 45° C. for 1 h to activate the enzyme. Second, the moulded mass was heat-treated at 95° C. for 1-2 hours, to achieve a core temperature of the mass above 71° C. for at least 2 min. Third, the mass was oven dried with an air circulation of 100% at 95° C. for 3-18 hours, depending on the number of oven plates/sample size in the oven. After drying, the dried mass was cooled to room temperature at cut into pieces which yielded to the texturized fruit-like inclusion product. The size ranged from 3 to 10 mm, or above, depending on the foreseen application.

As described for Example 1, the dry matter (TS), pH and A_{w} of the mass and texturized fruit-like inclusion product was determined using a moisture analyzer, pH meter, and Aw analyzer Aqualab 4TE, respectively.

### Examples 3 and 4

### Preparation of a Fruit-Like Inclusion Product Based on a High Apple Puree Content

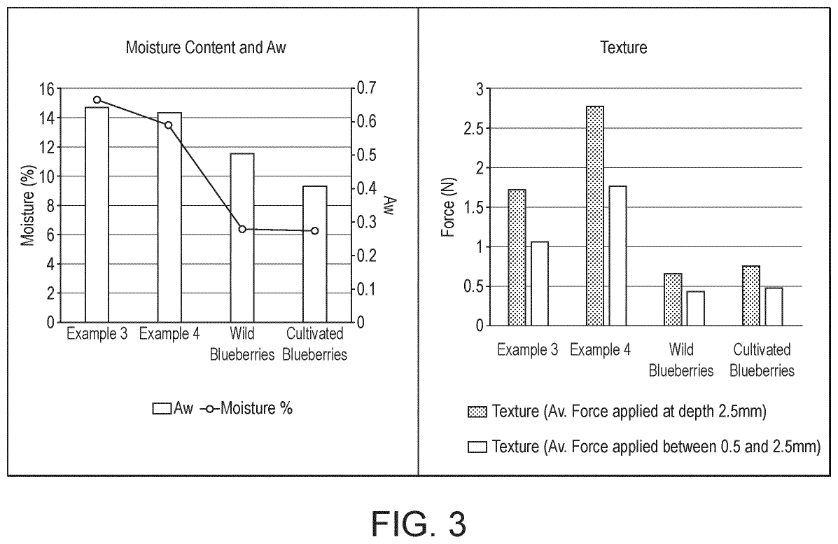

Recipes of Examples 3 and 4 comprised a high content of apple puree concentrate. Examples 3 and 4 were assessed for their moisture content, A_{w} value and texture. Compared to commercially available wild and cultivated blueberries, the moisture content and A_{w} value of Example 3 and 4 was slightly higher. The texture analysis using a texture analyzer and a depth ranging from 0.5 to 2.5 mm revealed a higher required force to penetrate the fruit-like inclusion products of Example 3 and 4 compared to commercially available wild and cultivated blueberries (FIG. 3).

| | Example 3 | Example 4 |
|---|---|---|
| Ingredient | %(w/w) | %(w/w) |
| Apple Puree Concentrate | 54.7 | 49.7 |
| Glucose Syrup | 10.4 | 18.4 |
| Apple Juice Concentrate | 18.0 | 14.0 |
| Apple Fiber | 7.7 | 7.7 |
| Citrus fiber (commercial | 2.4 | 3.4 |
| source) | | |
| Blueberry Powder | 4.9 | 4.9 |
| Citric Acid | 0.1 | 0.1 |
| Blueberry Flavor | 1.0 | 1.0 |
| Calcium Chloride | 0.6 | 0.6 |
| Dihydrate | | |
| Papain Preparation | 0.3 | 0.3 |
| Total weight (fresh) | 2500 g | 2500 g |
| Total weight (after drying) | 1600 g | 1800 g |
| TS after Drying (80° C.; | ~85% | ~85% |
| 3.5 h) | | |
| A_{w} | ~0.55 | ~0.58 |
| Comment | Flexible pieces, | Flexible gel, not |
| | not brittle, | brittle, more bendable |
| | bendable | compared to Example 3. |
| | | Preferred recipe in |
| | | this comparison |

Comparison of the texture analysis data of a fruit-like inclusions product based on Example 3 and 4 with commercially available wild and cultivated blueberries—Presentation as absolute values.

| | | | Mean F 1:2 (N) |
|---|---|---|---|
| | | Force 1 (N) | Average force |
| | | Force | applied |
| | | applied at | between 0.5 |
| Test ID | Batch | depth 2.5 mm | and 2.5 mm |
| Average: | Example 3 | 1.728 | 1.055 |
| S.D. | Example 3 | 0.326 | 0.25 |
| Coef. of Variation | Example 3 | 18.854 | 23.732 |
| Average: | Example 4 | 2.78 | 1.758 |
| S.D. | Example 4 | 0.962 | 0.598 |
| Coef. of Variation | Example 4 | 34.621 | 34.033 |
| Average: | Wild Blueberries | 0.661 | 0.443 |
| S.D. | Wild Blueberries | 0.174 | 0.136 |
| Coef. of Variation | Wild Blueberries | 26.388 | 30.645 |
| Average: | Cultivated | 0.757 | 0.485 |
| | Blueberries | | |
| S.D. | Cultivated | 0.548 | 0.327 |
| | Blueberries | | |
| Coef. of Variation | Cultivated | 72.297 | 67.394 |
| | Blueberries | | |

Comparison of the Aw and Moisture (%) values of a fruit-like inclusions product based on Example 3 and 4 with commercially available wild and cultivated blueberries (presentation as absolute values).

| | Aw | Moisture % |
|---|---|---|
| Example 3 | 0.643 | 15.2 |
| Example 4 | 0.626 | 13.42 |
| Wild Blueberries | 0.505 | 6.34 |
| Cultivated Blueberries | 0.407 | 6.19 |

### Examples 5 and 6

### Fruit-Like Inclusions Product Based on a Low Apple Puree Content

A second batch of a fruit-like inclusions product (Examples 5 and 6) was prepared using a lower amount of apple puree. The calculated nutritional value, based on product specification sheets of the used ingredients, of the prepared fruit-like inclusion products were compared to the one of commercially available blueberries (cultivated, apple juice infused) and fruit pieces (see table). The fiber content of Examples 5 and 6 (14.0 and 11.6% wt, respectively) was in the same range as reported for the blueberries (13.9% wt) and significantly higher compared to fruit pieces (3.4% wt). In addition, the non-dietary fiber carbohydrate content of Examples 5 and 6 (63.7 and 66.9% wt, respectively) was in the same range as reported for the blueberries (69.0% wt) and significantly lower compared to fruit pieces (89.1% wt). In summary, Examples 5 and 6 were close in their nutritional value like energy, carbohydrates including sugars, fibers, and sodium compared to commercially available blueberries (cultivated, apple juice infused).

Example 5 and 6 were assessed for their moisture content and A_{w} value. Based on sensory aspects (juiciness and texture), Example 6 was better compared to Example 6. The pH Example 5 and 6 ranged from 3.1 to 3.4.

Ingredients are specified in the description of Example 3 and 4.

| | Example 5 | Example 6 |
|---|---|---|
| Ingredient | %(w/w) | %(w/w) |
| Apple Puree Concentrate | 14.7 | 14.7 |
| Glucose Syrup | 18.0 | 25 |
| Apple Juice Concentrate | 26.8 | 25.0 |
| Apple Fiber | 7.7 | 6.0 |
| Citrus fiber (commercial | 2.7 | 3.0 |
| source) | | |
| Blueberry Powder | 4.9 | 4.9 |
| Citric Acid | 0.1 | 0.1 |
| Blueberry Flavor | 1.0 | 1.0 |
| Calcium Chloride | 0.6 | 0.6 |
| Dihydrate | | |
| Papain Preparation | 0.3 | 0.3 |
| Water (tap) | 23.2 | 19.5 |
| Total weight (fresh) | 2500 g | 2500 g |
| Total weight (after drying) | 1600 g | 1600 g |
| TS after Drying (80° C.; | ~90% | ~90% |
| 3.5 h) | | |
| A_{w} | ~0.48 | ~0.52 |
| Comment | Flexible fruit | Flexible gel, not brittle, |
| | pieces, not | bendable, softer and |
| | brittle, bendable | sweeter than Example 5, |
| | without breaking | therefore, Example 6 is |
| | | the preferred recipe in |
| | | this comparison |

Comparison of the nutritional value of the prepared fruit-like inclusion products to commercially available blueberries and fruit pieces

| | Commercial | Commercial | | |
|---|---|---|---|---|
| | Blueberries* | Fruit Pieces# | Example 5 | Example 6 |
| Nutritionals | Per 100 g | Per 100 g | Per 100 g | Per 100 g |
| Energy kJ | 1381 | 1472 | 1250 | 1295 |
| Energy kcal | 330 | 352 | 299 | 304 |
| Fat | 1.3 | 0.07 | 0.93 | 0.76 |
| of which: saturates | 0.1 | 0.05 | 0.06 | 0.04 |
| Carbohydrates | 68.96 | 89.06 | 63.73 | 66.9 |
| Of which: sugars | 59 | 85.65 | 54.44 | 55.76 |
| Flber | 13.85 | 3.41 | 14.03 | 11.57 |
| Protein | 3.68 | 0.42 | 1.85 | 1.56 |
| Sodium (mg) | 22.94 | 24 | 19.1 | 17.54 |

*commercially available cultivated and apple juice-infused blueberries;
#commercially available fruit pieces based on pectin as a gelling agent

### Examples 7 to 15

Different Heat Treatments with and without Enzyme Addition

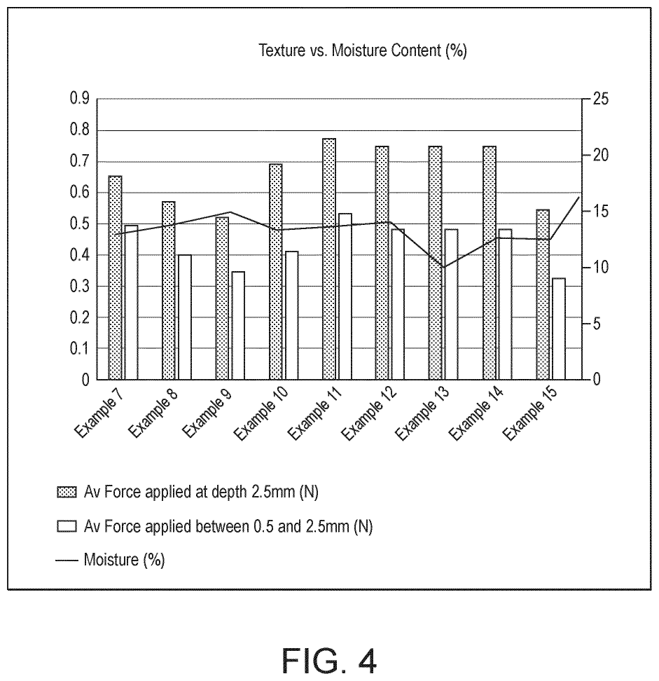

Fruit-like inclusion products were prepared based on different heat-treatments with and without enzyme addition. In total, 9 recipes were prepared. The samples were assessed for their visual appearance, taste, moisture content, texture, and A_{w} value. The texture analysis was done using a texture analyzer. A depth ranging from 0.5 to 2.5 mm revealed a higher required force to penetrate the fruit like inclusion product based on Example 10-14 (FIG. 4). Based on the visual appearance and taste, the developed recipes for Example 7, 8 & 9 led to the best fruit-like inclusion product properties. Moreover, based on the texture analysis, these three products were as soft as the commercially available wild and cultivated blueberries.

Examples 7, 9, 10, 12, 13 & 15 were prepared according to the process of Example 2. Example 8, 11, & 14 were prepared according to the process of Example 2 without the incubation step incubated at 45° C. for 1 h.

Ingredients are specified in the description of Example 3 and 4.

| | Example | Example | Example |
|---|---|---|---|
| | 7 & 8 | 10 & 11 | 13 & 14 |
| Ingredient | %(w/w) | %(w/w) | %(w/w) |
| Apple Puree | 14.7 | 14.7 | 12.5 |
| Concentrate | | | |
| Glucose Syrup | 25.0 | 30.0 | 25.5 |
| Apple Juice Concentrate | 25.0 | 19.2 | 28.5 |
| Apple Fiber | 6.0 | 6.0 | 4.5 |
| Citrus fiber (commercial | 3.0 | 3.0 | 2.5 |
| source) | | | |
| Blueberry Powder | 4.9 | 4.9 | 5.0 |
| Citric Acid | 0.1 | 0.1 | 0.2 |
| Blueberry Flavor | 1.0 | 1.0 | 1.5 |
| Calcium Chloride | 0.6 | 0.6 | 0.6 |
| Dihydrate | | | |
| Papain Preparation | 0.3 | 0.3 | 0.3 |
| Water (tap) | 19.4 | 20.2 | 18.9 |

| | Example 9 | Example 12 | Example 15 |
|---|---|---|---|
| Ingredient | %(w/w) | %(w/w) | %(w/w) |
| Apple Puree | 14.7 | 14.7 | 12.5 |
| Concentrate | | | |
| Glucose Syrup | 25.0 | 30.0 | 25.5 |
| Apple Juice Concentrate | 25.0 | 19.2 | 28.5 |
| Apple Fiber | 6.0 | 6.0 | 4.5 |
| Citrus fiber (commercial | 3.0 | 3.0 | 2.5 |
| source) | | | |
| Blueberry Powder | 4.9 | 4.9 | 5.0 |
| Citric Acid | 0.1 | 0.1 | 0.2 |
| Blueberry Flavor | 1.0 | 1.0 | 1.5 |
| Calcium Chloride | 0.6 | 0.6 | 0.6 |
| Dihydrate | | | |
| Papain Preparation | 0.0 | 0.0 | 0.0 |
| Water (tap) | 19.7 | 20.5 | 19.2 |

Weight before and after drying and Aw of Examples 7-15.

| | Weight (Kg) | Weight (Kg) after | A_{w} |
|---|---|---|---|
| Example | before drying | drying (Kg) | After drying |
| 7 | 7 | 4.4 | 0.43 |
| 8 | 1.5 | 1.0 | 0.52 |
| 9 | 1.5 | 1.0 | 0.51 |
| 10 | 7 | 4.4 | 0.50 |
| 11 | 1.5 | 1.1 | 0.55 |
| 12 | 1.5 | 1.0 | 0.49 |
| 13 | 3 | 2.3 | 0.44 |
| 14 | 1.5 | 1.0 | 0.43 |
| 15 | 1.5 | 1.0 | 0.56 |

Summary of the perceived appearance and sensory of Example 7-15.

| Examples | Evaluation | Conclusions |
|---|---|---|
| 7 | Short texture, tending to be “pasty”. Lack off | Preferred |
| | cohesiveness. Very fruity, Not sticky, Need | Example |
| | more viscosity, more towards gummy-like | |
| | texture to last longer, more juicy than | |
| | Example 9 | |
| 8 | Good taste, acidic, juicy, softer than Example | Preferred |
| | 7 and 9 | Example |
| 9 | Similar taste attributes as Example 7 & 8, | Preferred |
| | Softer than Example 7 | Example |

| Examples | Evaluation | Conclusions |
|---|---|---|
| 10 | Drier than Example 7-9, dry fiber, firm, | Alternative to |
| | sawdust effect | Example 7 |
| 11 | Without incubation characteristics similar to | Alternative to |
| | samples with incubation | Example 8 |
| 12 | Moister than Example 7-9 | Alternative to |
| | | Example 9 |
| 13 | More viscous and sticky. Chewier than | Not preferred |
| | Example 7-12. Hangs around longer. Lost | Example |
| | moistness a bit, very fruity. Acidic ‘makes | |
| | your mouth water’ | |
| 14 | Softer than Example 13 | Not preferred |
| | | Example |
| 15 | Moister, a bit less firm/elastic than Example | Not preferred |
| | 13 | Example |

### Examples 16 to 21

### Other Flavours

Fruit-like inclusions product comprising different flavours were prepared. In total, six recipes were prepared which corresponded Example 16 to 21. The samples were assessed for their visual appearance, taste, and A_{w} value.

The cherry flavoured Example 16 was obtained by the addition of commercially available freeze-dried soured cherry powder. For Example 17, the blueberry flavour was obtained by the addition of fresh blueberries, which were pre-cooked above 95° C. for 10 min using a Thermomix (Agitation; Step 2). The recipe of Example 18 contained coffee mucilage which is isolated from the sticky layer of the pulp (inner mesocarp) from the coffee bean. It is a by-product from the wet processing of coffee cherries. The mucilage had a carbohydrate content of at least 60% wt. Example 19 had a cascara flavour. The flavour was generated by cooking 80 g of dried cascara pulp (from the coffee bean) in 400 water at 90° C. for 15 min (Agitation step 3). The final TS of the extract was above 7% wt. This extract was added to the recipe of Example 19. The blueberry flavour of Example 20 and 21 was created by the addition of blueberry puree and a mixture of blueberry puree and blueberry juice concentrate, respectively. The preferred fruit-like inclusion product Example 20 and 21, whereas the flavour and colour were less intense compared to Example 7, 8, & 9, which were based on blueberry powder. Recipes were further optimized to investigate the replacement of blueberry powder by blueberry puree and blueberry juice concentrate. see Example 22-31.

Examples 16-21 were prepared according to the process of Example 2. The main ingredients are specified in the description of Example 3 and 4. The flavour specific ingredients of Example 16-21 are described below.

| | | Example 17 | Example 18 |
|---|---|---|---|
| | Example 16 | Fresh | Coffee |
| | Sour Cherry | Blueberries | Mucilage |
| Ingredient | %(w/w) | %(w/w) | %(w/w) |
| Apple Puree Concentrate | 14.7 | 10.7 | 14.7 |
| Glucose Syrup | 25.0 | 18.3 | 25.0 |
| Apple Juice Concentrate | 25.0 | 18.3 | 25.0 |
| Apple Fiber | 6.0 | 4.4 | 6.0 |
| Citrus fiber (commercial | 3.0 | 2.2 | 3.0 |
| source) | | | |
| Soured Cherry Powder | 5.9 | 0 | 0 |
| Fresh Blueberries | 0 | 44.7 | 0 |
| Coffee Mucilage | 0 | 0 | 20.0 |
| Citric Acid anhydrous | 0.1 | 0.1 | 0.1 |
| Blueberry Flavor | 0.0 | 0.7 | 0.0 |
| Calcium Chloride Dihydrate | 0.6 | 0.4 | 0.6 |
| Papain Preparation | 0.3 | 0.2 | 0.3 |
| Water (tap) | 19.4 | 0 | 5.3 |
| Total weight (g, fresh) | 2000 | 2739 | 2000 |
| Total weight (g, after drying) | 1130 | 1400 | 1030 |
| A_{w} | 0.45 | 0.45 | 0.43 |

| | Example 19 | Example 20 | Example 21 |
|---|---|---|---|
| | Cascara | Blueberry | Blueberry |
| | Pulp | Puree | Puree & Juice |
| Ingredient | %(w/w) | %(w/w) | %(w/w) |
| Apple Puree Concentrate | 14.7 | 0.0 | 0.0 |
| Glucose Syrup | 22.5 | 26.3 | 25.5 |
| Apple Juice Concentrate | 22.5 | 26.3 | 16.3 |
| Apple Fiber | 6.0 | 6.3 | 6.1 |
| Citrus fiber (commercial | 3.0 | 3.2 | 3.1 |
| source) | | | |
| Blueberry Puree | 0 | 35.8 | 12.3 |
| Blueberry Juice | 0 | 0 | 34.7 |
| Concentrate | | | |
| Cascara (80 g extracted | 10.0 | 0 | 0 |
| with 400 mL ~7.6 TS % wt | | | |
| expected) | | | |
| Citric Acid | 0.1 | 0.1 | 0.1 |
| Blueberry Flavor | 0.0 | 1.0 | 1.0 |
| Calcium Chloride | 0.6 | 0.6 | 0.6 |
| Dihydrate | | | |
| Papain Preparation | 0.3 | 0.3 | 0.3 |
| Water (tap) | 20.3 | 0 | 0 |
| Total weight (g, fresh) | 2100 | 2000 | 2000 |
| Total weight (g, after | 1150 | 1300 | 1400 |
| drying) | | | |
| A_{w} | 0.45 | 0.50 | 0.52 |

### Examples 22 to 31

Comparison of Blueberry Powder with Blueberry Puree and Blueberry Juice

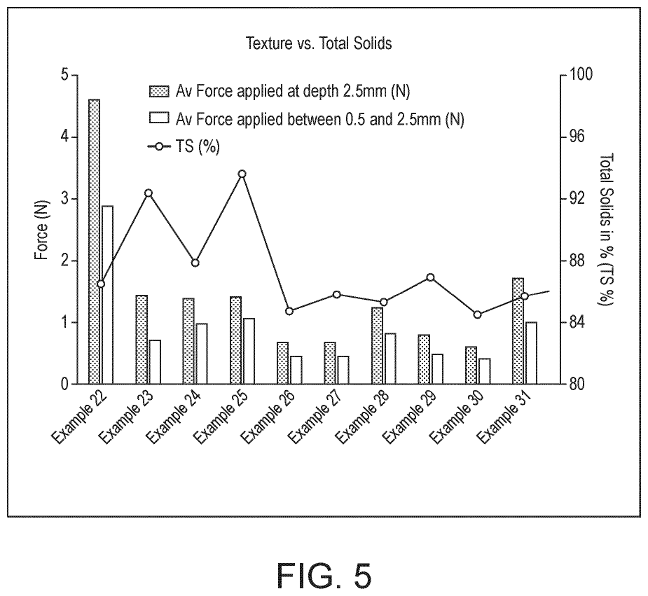

The preparation of a fruit-like inclusion product comprising blueberry puree and blueberry juice concentrate instead of blueberry powder. In total, ten fruit-like inclusion product variants were prepared. Six out of ten examples were prepared using a papain preparation, calcium chloride, and citric acid. In addition, the latter three ingredients were replaced by lemon juice only to obtain four fruit-like inclusion products which are considered as ‘clean label products’. All samples were assessed for their visual appearance, taste, moisture content, texture, and A_{w} value (FIG. 5). The final TS of the fruit-like inclusion products ranged from 84 to 94%. The determined A_{w} value was between 0.53 and 0.56.

Examples 22-31 were prepared according to the process of Example 2.

The main ingredients are specified in the description of Example 3 and 4. Blueberry juice concentrate and blueberry puree are specified in the description of Example 16-21. To further improve the colour of the fruit-like inclusion product, Example 30 & 31 contained added red beetroot powder. The specification of the red beetroot powder and the lemon juice are described below.

Based on the visual appearance and taste of the fruit-like inclusion products, Example 23, 25, 27, and 29 were perceived as the best products. These products were prepared without the addition of papain and calcium and, as mentioned above, ‘clean label products’. Example 26 and 27 were the softer compared to Example 22-25 & 28-31. The addition of ret beetroot powder masked the blueberry flavour and juiciness. Therefore, Example 30 & 31 were the least preferred samples.

| | Example 22 | Example 23 |
|---|---|---|
| Ingredient | %(w/w) | Weight (g) |
| Apple Puree | 14.7 | 14.7 |
| Concentrate | | |
| Glucose Syrup | 25.0 | 25.0 |
| Apple Juice | 25.0 | 25.0 |
| Concentrate | | |
| Apple Fiber | 6.0 | 6.0 |
| Citrus fiber | 3.0 | 3.0 |
| (commercial | | |
| source) | | |
| Blueberry Powder | 4.9 | 4.9 |
| Citric Acid | 0.1 | 0 |
| anhydrous | | |
| Lemon Juice | 0 | 2.2 |
| Blueberry Flavor | 1.0 | 1.0 |
| Calcium Chloride | 0.6 | 0.0 |
| Dihydrate | | |
| Papain Preparation | 0.3 | 0.0 |
| Water (tap) | 19.4 | 18.2 |
| Total weight (g, | 3000 | 3000 |
| fresh) | | |
| | Example 24 | Example 25 |
| Ingredient | %(w/w) | %(w/w) |
| Apple Puree | 8.0 | 8.0 |
| Concentrate | | |
| Glucose Syrup | 30.0 | 30.0 |
| Apple Juice | 28.0 | 28.0 |
| Concentrate | | |
| Apple Fiber | 4.5 | 4.5 |
| Citrus fiber | 3.5 | 3.5 |
| (commercial | | |
| source) | | |
| Blueberry Powder | 5.0 | 5.0 |
| Citric Acid | 0.2 | 0.0 |
| anhydrous | | |
| Lemon Juice | 0.0 | 4.4 |
| Blueberry Flavor | 1.0 | 0.0 |
| Calcium Chloride | 0.6 | 0.0 |
| Dihydrate | | |
| Papain Preparation | 0.3 | 0.0 |
| Water (tap) | 18.4 | 15.1 |
| Total weight (g, | 3000 | 3000 |
| fresh) | | |
| | Example 26 | Example 27 |
| Ingredient | %(w/w) | Weight (g) |
| Apple Puree | 0.0 | 0.0 |
| Concentrate | | |
| Glucose Syrup | 31.0 | 31.0 |
| Apple Juice | 20.8 | 20.8 |
| Concentrate | | |
| Apple Fiber | 6.3 | 6.3 |
| Citrus fiber | 4.0 | 4.0 |
| (commercial | | |
| source) | | |
| Blueberry Juice | 0 | 0 |
| Concentrate | | |
| Blueberry Puree | 35.8 | 35.8 |
| Citric Acid | 0.1 | 0.0 |
| anhydrous | | |
| Lemon Juice | 0.0 | 1.0 |
| Blueberry Flavor | 1.0 | 1.0 |
| Calcium Chloride | 0.6 | 0.0 |
| Dihydrate | | |
| Papain Preparation | 0.3 | 0.0 |
| Water (tap) | 0 | 0 |
| Total weight (g, | 2000 | 2000 |
| fresh) | | |
| | Example 28 | Example 29 |
| Ingredient | %(w/w) | %(w/w) |
| Apple Puree | 0.0 | 0.0 |
| Concentrate | | |
| Glucose Syrup | 31.0 | 31.0 |
| Apple Juice | 10.5 | 10.5 |
| Concentrate | | |
| Apple Fiber | 5.5 | 5.5 |
| Citrus fiber | 4.0 | 4.0 |
| (commercial | | |
| source) | | |
| Blueberry Juice | 12.3 | 12.3 |
| Concentrate | | |
| Blueberry Puree | 34.7 | 34.7 |
| Citric Acid | 0.1 | 0.0 |
| anhydrous | | |
| Lemon Juice | 0.0 | 1.0 |
| Blueberry Flavor | 1.0 | 1.0 |
| Calcium Chloride | 0.6 | 0.0 |
| Dihydrate | | |
| Papain Preparation | 0.3 | 0 |
| Water (tap) | 0 | 0 |
| Total weight (g, | 2000 | 2000 |
| fresh) | | |
| | Example 30 | Example 31 |
| Ingredient | %(w/w) | Weight (g) |
| Apple Puree | 0.0 | 0.0 |
| Concentrate | | |
| Glucose Syrup | 28.8 | 29.0 |
| Apple Juice | 20.0 | 9.5 |
| Concentrate | | |
| Apple Fiber | 3.3 | 2.5 |
| Red Beetroot | 6.0 | 6.0 |
| pomace | | |
| Citrus fiber | 4.0 | 4.0 |
| (commercial | | |
| source) | | |
| Blueberry Juice | 0 | 12.3 |
| Concentrate | | |
| Blueberry Puree | 35.8 | 34.7 |
| Citric Acid | 0.1 | 0.1 |
| anhydrous | | |
| Lemon Juice* | xx | xx |
| Blueberry Flavor | 1.0 | 1.0 |
| Calcium Chloride | 0.6 | 0.6 |
| Dihydrate | | |
| Papain Preparation | 0.3 | 0.3 |
| Water (tap) | 0 | 0 |
| Total weight (g, | 2000 | 2000 |
| fresh) | | |

| | Weight (Kg) | pH | Weight (Kg) | A_{w} | A_{w} | TS (%) | Final TS (%) |
|---|---|---|---|---|---|---|---|
| | before | before | after | Before | After | Before | After |
| Example | drying | drying | drying (Kg) | drying | drying | drying | drying |
| 22 | 3.0 | 3.1 | 1.7 | 0.89 | 0.52 | 58.9 | 86.5 |
| 23 | 3.0 | 3.4 | 1.7 | 0.90 | 0.53 | 64.2 | 92.4 |
| 24 | 3.0 | 3 | 1.7 | 0.87 | 0.53 | 61.3 | 87.9 |
| 25 | 2.0 | 3.3 | 1.7 | 0.91 | 0.53 | 66.9 | 93.6 |
| 26 | 2.0 | 3 | 1 | 0.90 | 0.56 | 53.2 | 84.7 |
| 27 | 2.0 | 3.4 | 1 | 0.90 | 0.56 | 55.6 | 85.8 |
| 28 | 2.0 | 3 | 1 | 0.89 | 0.54 | 55.2 | 85.3 |
| 29 | 2.0 | 3.3 | 1 | 0.89 | 0.53 | 57.5 | 86.9 |
| 30 | 2.0 | 3.3 | 1 | 0.91 | 0.56 | 52.8 | 84.5 |
| 31 | 2.0 | 3.2 | 1 | 0.91 | 0.56 | 53.6 | 85.7 |

| | | | | Preferred |
|---|---|---|---|---|
| Example | Aspect | Texture | Taste | Recipe by |
| 22 | Mat, nice violet | Very hard & firm, dry | Acidic, blueberry | — |
| | color | Very hard, dry | Fruity | |
| | Dark | | | |
| 23 | Glossy/shiny, | Softer than 1, juicier, good | Less acidic than | Preferred |
| | nice violet color | elasticity. More tender | Example 22, blueberry | Example |
| | | than Example 22 | (less pronounced than | |
| | | | Example 22) | |
| | | | More juicy than | |
| | | | Example 22 , fruity | |
| 24 | Mat, violet color | Very soft, juicy | Less acidic, sweeter, | — |
| | Good colour | Short, a little dry | blueberry | |
| | | | Tangy | |
| 25 | Some glossy | Well balanced, not too | Well balanced between | Preferred |
| | spots, violet | hard, elastic & chewy. | acidity and blueberry | Example |
| | | Weaker gel | Juicier, flavour a little | |
| | | | weak | |
| 26 | Mat, dark brown | Very soft | Slightly acidic, light | — |
| | Colour | Crumbly structure (cake- | blueberry taste | |
| | degraded | like) | Acidic | |
| 27 | Shiny, dark | Soft but elastic | No acidity, Light taste | Preferred |
| | brown | Short, juicy texture | Flavour weak | Example |
| | Colour dark | | | |
| 28 | Mat, dark brown | Soft | Acidic, more blueberry | — |
| | | Firm, dry | vs Example 27 | |
| | | | Weak flavour, strong | |
| | | | acid | |
| 29 | Mat, dark brown | More elastic than Example | Acidic, more blueberry | Preferred |
| | | 28, chewy and juicy | vs Example 27 | Example |
| | | Short, quite firm | Acid tangy, quite juicy | |
| 30 | Mat, light brown | Elastic & dry | Acidic, no real blueberry | Less |
| | | Short, weaker gel | flavor, a bit pasty | preferred |
| | | | Juicy, flavour weak, | |
| | | | tangy | |
| 31 | Mat, light brown | Elastic & dry | Acidic, no real blueberry | Less |
| | | Dry, leathery | flavor, a bit pasty, | preferred |
| | | | Flavour weak | |

### Examples 32 and 33

### Preparation of a Sweet Cherry-Flavoured Fruit-Like Inclusions Product

A fruit-like inclusion product comprising sweet cherry puree was prepared. Two fruit-like inclusion product variants were prepared. Example 32 was prepared using a papain preparation and calcium chloride. In case of Example 33, the latter ingredients were not added to the recipe. All samples were assessed for their visual appearance, taste, moisture content, texture, and A_{w} value. The final TS and Aw value of the fruit-like inclusion products was about 86% and 0.55, respectively.

Both Example 32 and 33 were equally soft. During the drying process, the products became brownish. In a direct comparison, both products were not strong enough in their cherry flavour and had a similar texture and appearance.

Examples 32-33 were prepared according to the process of Example 2. The main ingredients are specified in the description of Example 3 and 4.

| | Example 32 | Example 33 |
|---|---|---|
| Ingredient | %(w/w) | %(w/w) |
| Glucose Syrup | 29.2 | 29.4 |
| Apple Juice | 18.3 | 18.4 |
| Concentrate | | |
| Apple Fiber | 3.2 | 3.3 |
| Red Beetroot pomace | 5.8 | 5.9 |
| Citrus fiber | 3.9 | 3.9 |
| (commercial source) | | |
| Sweet Cherry Puree | 34.8 | 35.1 |
| Lemon Juice* | 2.9 | 2.9 |
| Calcium Chloride | 0.6 | 0.0 |
| Dihydrate | | |
| Papain Preparation | 0.3 | 0.0 |
| Total weight (g, fresh) | 2057 | 2039 |

| | Weight (Kg) | pH | Weight (Kg) | A_{w} | A_{w} | TS (%) | Final TS (%) |
|---|---|---|---|---|---|---|---|
| | before | before | after | Before | After | Before | After |
| Example | drying | drying | drying (Kg) | drying | drying | drying | drying |
| 32 | 2.0 | 3.4 | 1.0 | 0.90 | 0.54 | 56.5 | 86.3 |
| 33 | 2.0 | 3.6 | 1.0 | 0.91 | 0.56 | 58.3 | 86.7 |

### Examples 34 to 37

Effect of Apple Puree Concentrate and Apple Puree Addition, in Combination with Enzyme

Fruit-like inclusion products were prepared using either apple puree concentrate (Example 36), apple puree (Example 34 & 35) and blueberry juice and puree (Example 37) as an alternative. The preparation of one Example 34 included the use of and enzyme preparation. The final TS and A_{w} value of the four products ranged from 88 to 92% and 0.42 and 0.51, respectively. Overall, the fruit-like inclusions of Example 36 & 37 were considered better in their taste and texture appearance compared to the samples that were prepared with commercial apple puree (Example 34 & 35). The fruit-like inclusions prepared with papain addition were softer compared to the once without papain addition, which resulted in the breakage of the dried fruit-like inclusion ‘boards’.

Examples 34-37 were prepared according to the process of Example 2. The main ingredients are specified in the description of Example 3 and 4.

| | Example 34 | Example 35 |
|---|---|---|
| Ingredient | %(w/w) | Weight (g) |
| Apple Puree | 0.0 | 0.0 |
| Concentrate (TS >30%) | | |
| Apple Puree (TS ~13- | 8.0 | 8.0 |
| 15%) | | |
| Glucose Syrup | 30.0 | 30.0 |
| Apple Juice Concentrate | 32.0 | 32.0 |
| Apple Fiber | 6.0 | 6.0 |
| Citrus fiber (commercial | 2.5 | 2.5 |
| source) | | |
| Blueberry Powder | 5.0 | 5.0 |
| Blueberry Juice | 0 | 0 |
| Concentrate | | |
| Blueberry Puree 10 BX | 0 | 0 |
| Lemon Juice | 1.6 | 1.6 |
| Blueberry Flavor | 1.5 | 1.5 |
| Calcium Chloride | 0.6 | 0.0 |
| Dihydrate | | |
| Papain Preparation | 0.3 | 0.0 |
| Water (tap) | 12.5 | 13.4 |
| Total weight (g, fresh) | 18000.0 | 18000.0 |
| | Example 36 | Example 37 |
| Ingredient | %(w/w) | %(w/w) |
| Apple Puree | 8.0 | 0.0 |
| Concentrate (TS >30%) | | |
| Apple Puree (TS ~13- | 0.0 | 0.0 |
| 15%) | | |
| Glucose Syrup | 30.0 | 29.0 |
| Apple Juice Concentrate | 32.0 | 13.0 |
| Apple Fiber | 6.0 | 7.0 |
| Citrus fiber (commercial | 2.5 | 3.0 |
| source) | | |
| Blueberry Powder | 5.0 | 0 |
| Blueberry Juice | 0 | 12.3 |
| Concentrate | | |
| Blueberry Puree 10 BX | 0 | 33.2 |
| Lemon Juice | 1.6 | 1.5 |
| Blueberry Flavor | 1.5 | 1.0 |
| Calcium Chloride | 0.0 | 0.0 |
| Dihydrate | | |
| Papain Preparation | 0.0 | 0.0 |
| Water (tap) | 13.4 | 0 |
| Total weight (g, fresh) | 18000.0 | 18000.0 |

| | Weight (Kg) | pH | Weight (Kg) | A_{w} | A_{w} | TS (%) | Final TS (%) |
|---|---|---|---|---|---|---|---|
| | before | before | after | Before | After | Before | After |
| Example | drying | drying | drying (Kg) | drying | drying | drying | drying |
| 34 | 18 | 3.1 | 11.54 | 0.85 | 0.42 | 69 | 91.2 |
| 35 | 18 | 3.3 | 11.84 | 0.85 | 0.5 | 65 | 88.9 |
| 36 | 18 | 3.3 | 12 | 0.85 | 0.51 | 65 | 88.6 |
| 37 | 18 | 3.2 | 12 | 0.87 | 0.44 | 59 | 91.6 |

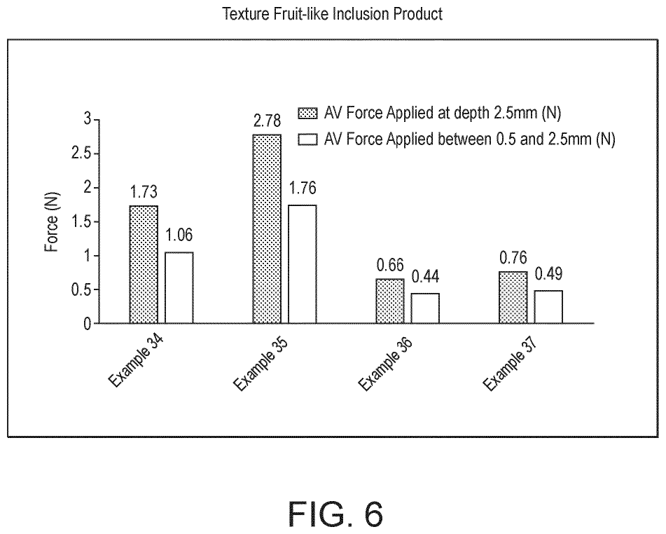

FIG. 6 shows a texture comparison of four fruit-like inclusion products (Example 34-37). The texture of Examples 36 and 37 were softer compared to Example 34 and 35. Moreover, the texture of Examples 36 and 37 was close to the measured texture of commercially available wild and cultivated blueberries (see description in Example 3 & 4).

### Example 38

### Fiber Content of Selected Fruit-Like Inclusion Products

To further determine the fiber content of the fruit-like inclusion product, five samples were analyzed for total uronic acid, total dietary fiber, Low Molecular Weight Dietary Fiber (LMWDF), Insoluble High Molar Weight Dietary Fiber (HMWDF), and Soluble High Molar Weight Dietary Fiber (HMWDF).

Overall, all five products are similar in their dietary fiber content, as well as in their dietary fiber profile. The estimated ‘Carbohydrate to dietary fiber’ content ranged from 4.1 to 5.2. The ratio between ‘soluble dietary fiber to insoluble dietary fiber’ ranged from 0.29 to 0.38. One of the most unique features of the fruit-like inclusion product is the high dietary fiber content, which is close to the dietary fiber content determined for apple juice-infused blueberries (cultivated).

| Composition of Fruit-like Inclusions | | Example 7 | Example 21 | Example 25 | Example 36 | Example 37 |
|---|---|---|---|---|---|---|
| Ingredients/Recipes %(w/w) | | | | | | |
| fresh | | | | | | |
| Total uronic acid | % | 2.90 | 3.10 | 2.80 | 2.70 | 3.40 |
| | (w/w) | | | | | |
| Total dietary fiber (sum) | % | 12.80 | 12.80 | 13.60 | 14.20 | 15.50 |
| | (w/w) | | | | | |
| Low Molecular Weight Dietary | % | 2.10 | 2.30 | 2.70 | 3.80 | 3.90 |
| Fiber (LMWDF) | (w/w) | | | | | |
| Insoluble High Molar Weight | % | 8.30 | 7.70 | 8.20 | 7.60 | 8.40 |
| Dietary Fiber (HMWDF) | (w/w) | | | | | |
| Soluble High Molar Weight | % | 2.40 | 2.80 | 2.70 | 2.80 | 3.20 |
| Dietary Fiber (HMWDF) | (w/w) | | | | | |
| “Carbohydrate to dietary fiber” - | | | | | | |
| Total Dietary Fiber | | | | | | |
| Ø based on 64% Carbohydrates* | % | 5.00 | 5.00 | 4.71 | 4.51 | 4.13 |
| | (w/w) | | | | | |
| Ø based on 67% Carbohydrates* | % | 5.23 | 5.23 | 4.93 | 4.72 | 4.32 |
| | (w/w) | | | | | |

*Carbohydrate content was calculated based on the nutritional specifications/product specifications of the used ingredients under consideration of the water evaporation during the drying process.

1. A texturized fruit-like inclusion product, said product comprising
a. 50 to 80 wt % non-dietary fiber carbohydrate;
b. 5 to 20 wt % dietary fiber; and
c. the ratio of wt % dietary fiber to wt % non-dietary fiber carbohydrate is between 1:10 to 1:2.

2. The product according to claim 1, wherein the product comprises between 0.1 to 2 wt % calcium source.

3. The product according to claim 1, wherein the product comprises about 25 wt % glucose syrup.

4. The product according to claim 1, wherein the product has a fructose to glucose ratio of between 1:1 to 2:1.

5. The product according to claim 1, wherein the dietary fiber is citrus fiber.

6. The product according to claim 1, wherein the calcium source is calcium chloride.

7. The product according to claim 1, wherein the product has a water activity (A_{w}) between 0.45 and 0.65 and a pH of about 3.4.

8. The product according to claim 1, wherein the product has a total solids (TS) content of between 80 to 95%.

9. The product according to claim 1, wherein the product comprises apple and blueberry derived ingredients.

10. (canceled)

11. A method of making a texturized fruit-like inclusion product, said method comprising
a. Mixing a non-dietary fiber carbohydrate source and a dietary fiber source in water to form a mixture;
b. Incubating the mixture in a mold so that the temperature of the mixture reaches between 40 to 65° C.;
c. Drying the mixture; and
d. Cutting the mixture to form a product.

12. The method according to claim 11, wherein the mixture comprises ingredients derived from different fruit sources.

13. The method according to claim 11, wherein the pectin methylesterase source is a papain preparation derived from a papaya plant.

14. (canceled)
